(19) United States
(12) Patent Application Publication
(10) Pub. No.: US 2019/0176592 A1
(43) Pub. Date: Jun. 13, 2019

(54) THREE-POINT SUPPORT OF A SLIDING DOOR

(71) Applicant: Gebr. Bode GmbH & Co. KG, Kassel (DE)

(72) Inventors: Christoph Theis, Bad Wildungen (DE); Abbas Rasekhi, Kassel (DE); Ulrich Arend, Homburg (DE)

(21) Appl. No.: 16/310,085

(22) PCT Filed: Jun. 16, 2017
(86) PCT No.: PCT/EP2017/064762

§ 371 Date: Dec. 14, 2018

(30) Foreign Application Priority Data
Jun. 16, 2016 (DE) 10 2016 111 069.8
May 9, 2017 (DE) 20 2017 102 755.4

(51) Int. Cl. B60J 5/06; B61D 19/00; E05D 15/06

(52) U.S. Cl. CPC B60J 5/062; B61D 19/005; E05D 15/063; E05Y 2900/51; E05Y 2201/64; E05Y 2800/266; E05D 15/0665

(57) ABSTRACT

Device for guiding a door element, for example, a sliding door for a passenger transport vehicle, has a first and a second guiding profiled element, wherein the two guiding profiled elements are arranged parallel to each other at a distance from each other, and three guiding elements in total, by means of which the door element is guidably connected to the two guiding profiled elements, wherein two of the guiding elements are guidably arranged on the first guiding profiled element and one of the guiding elements is guidably arranged on the second guiding profiled element.

### CROSS-REFERENCE TO RELATED APPLICATIONS

This application is a national stage application of international application no. PCT/EP2017/064762 filed Jun. 16, 2017, entitled “Three-Point Support of a Sliding Door,” claiming priority to German application no. DE 10 2016 111 069.8 filed Jun. 16, 2016, and German application no. DE 20 2017 102 755.4 filed May 9, 2017, which are hereby expressly incorporated by reference as part of the present disclosure.

### FIELD OF THE INVENTION

The present disclosure generally relates to a device for guiding a door element, for example, a sliding door for a passenger transport vehicle, such as rail vehicles of public transport.

### BACKGROUND

Such devices are known from the prior art. In such devices, the sliding doors are generally guided in the upper region in a suspended manner by a guiding system. A targeted limitation to freedom takes place here in a translatory manner in all axes and in a rotatory manner—owing to the suspension—horizontally in the axis transversely to the sliding direction and in the vertical axis. A rotatorily horizontal targeted limitation to freedom in the axis of the sliding direction is not necessary owing to the center of gravity of the sliding door lying not far from the guiding system. In such devices, the sliding door is therefore undefined in the lower region and therefore not limited in a targeted manner, for example in a U-shaped profiled element.

In an alternative device known from the prior art, the sliding doors are guided in the lower region, for example by means of runners. In such a device, also, a targeted limitation to freedom takes place in a translatory manner in all axes and in a rotatory manner—owing to the running system—horizontally in the axis transversely to the sliding direction and in the vertical axis. This device also does not have a rotatorily horizontal targeted limitation to freedom in the axis of the sliding direction.

In addition, a device with a limitation lying transversely to the sliding direction is known. In such a device, a plurality of runners are arranged as much as possible at the maximum distance from one another—in relation to the axis of the sliding direction—on the sliding door. Owing to the risk of the sliding door jamming, a high degree of accuracy of the guiding profiled element in which the runners run is necessary, because the runners are set to permanent abutment during installation.

### SUMMARY

It is therefore an object to provide a device for guiding a door element, for example, a sliding door for a passenger transport vehicle. It is a further object to provide a device for guiding a door element which permits a targeted guidance in all degrees of freedom, in a translatory and rotatory manner.

Advantageous embodiments and variants will emerge to one of ordinary skill in the art from the description herein and drawings.

According to at least some embodiments, a device for guiding a door element, for example a sliding door for a passenger transport vehicle, has a first and a second guiding profiled element, wherein the two guiding profiled elements are arranged parallel to each other and at a distance from each other. In addition, the device has guiding elements, by means of which the door element is guidably connected to the two guiding profiled elements, wherein two of the guiding elements are guidably arranged on the first guiding profiled element and one of the guiding elements is guidably arranged on the second guiding profiled element.

Such a device with a three-point guide permits a targeted limitation to freedom in a translatory and rotatory manner in all axes, so that the door element is given almost no play which leads to a shaking of the door element during vehicle operation. In particular, through the realized three-point guide, high tolerances are balanced out between the two guiding profiled elements, so that a jamming of the door element is efficiently prevented. As no high degrees of accuracy have to be set for the guiding profiled elements, the device according to at least one embodiment can be produced more favourably compared to devices known from the prior art.

In one aspect, a device for guiding a door element includes two guiding profiled elements oriented parallel to each other and three guiding elements connecting or contacting the door element with the two guiding profiled elements. Two of the guiding elements are located on the first guiding profiled element and one is located on the second guiding profiled element. The guiding elements are arranged substantially in a V-shape. Two of the guiding elements are located at or near two corners of the door element and a third is located on the opposite end of the door element from the two corners, forming a substantially equally-sided triangle.

In a further aspect, the door element is a sliding door for a passenger transport vehicle.

According to at least one embodiment, the three guiding elements are arranged on the door element in a V-shape to one another. The three guiding elements therefore encompass a triangle which is formed substantially in an equal-sided manner, so that two of the guiding elements are arranged in the corners of the door element—in relation to the axis of the sliding direction, e.g., at a maximum distance from one another. The remaining one guiding element is then arranged—in relation to the extent of the door element—at the opposite end of the door element centrally in sliding direction of the axis.

In at least one embodiment, the first guiding profiled element is arranged in relation to the extent of the door element at a first upper end, and the second guiding profiled element is arranged accordingly at an opposite second lower end of the device, so that the door element is mounted on the vehicle by means of a total of two guiding profiled elements.

In an alternative embodiment, the first guiding profiled element can be arranged at the second lower end and the second guiding profiled element can be arranged at the first upper end, i.e. the three guiding elements on the door element are arranged in a reverse V-shape to one another.

The distance between the first and the second guiding profiled element can correspond substantially to the extent of the door element. The distance of the two guiding profiled elements from one another can therefore be dependent on the shape of the door element. In so far as the door element is embodied so as to be flat, the distance corresponds substantially to the length of the door element. In so far as the door element is embodied so as to be bent, the distance corresponds substantially to a straight line which intersects the bent function at two points.

In a further embodiment, the door element is a door element configured in a C-shape or generally C-shaped.

In some embodiments, each of the three guiding elements comprises at least one runner. The guiding element can comprise, in addition, an arm, wherein the arm is securely connected by one end to the door element and at the other end slides via the runner in the guiding profiled element.

In an alternative embodiment, the guiding system can also be embodied in a suspended manner.

In some embodiments, the two guiding profiled elements are embodied so as to be substantially U-shaped and have a first and second contact surface. Hereby, a guiding channel is produced within the guiding profiled element, in which guiding channel the guiding element, in particular the runners, can be guided in a sliding manner.

In some embodiments, the distance between the first and the second con-tact surface of the guiding profiled element corresponds to the diameter of the runners. In particular, hereby in the guiding profiled element in which the one guiding element is guidably arranged, the rotatorily horizontal limitation to freedom—in the axis of the sliding direction—is again improved.

In further aspects, a passenger transport vehicle includes a device for guiding a door element, which may be a device as described herein and/or in the drawings.

This summary is not exhaustive of the scope of the present aspects and embodiments. Thus, while certain aspects and embodiments have been presented and/or outlined in this summary, it should be understood that the present aspects and embodiments are not limited to the aspects and embodiments in this summary. Indeed, other aspects and embodiments, which may be similar to and/or different from, the aspects and embodiments presented in this summary, will be apparent from the description, illustrations, and/or claims, which follow.

It should also be understood that any aspects and embodiments that are described in this summary and do not appear in the claims that follow are preserved for later presentation in this application or in one or more continuation patent applications.

### BRIEF DESCRIPTION OF THE DRAWINGS

Further details and advantages will become apparent from the following description with the aid of examples, which are to be understood not to be limiting, and with reference to the drawings.

FIG. 1 is a front view of a device for guiding a door; and

FIG. 2 is a cross-sectional view of the device of FIG. 1 along section A-A′.

### DETAILED DESCRIPTION

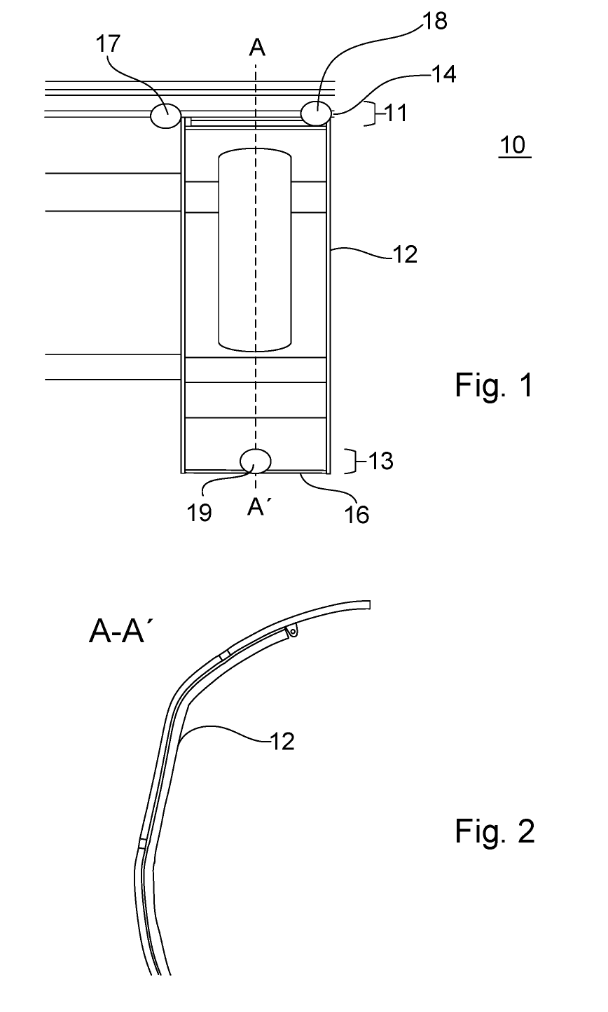

FIG. 1 shows a frontal illustration of a device 10 for guiding a door element 12, for example, a sliding door for a passenger transport vehicle. The device 10 has a first guiding profiled element 14 and a second guiding profiled element 16, wherein the two guiding profiled elements 14, 16 are arranged parallel to each other at a distance from each other. The distance of the two guiding profiled elements 14, 16 corresponds substantially to the extent or length of the door element 12. In addition, the device 10 has three guiding elements 17, 18, 19 in total in this embodiment, by means of which the door element 12 is in contact or connected, e.g., slidingly, with the two guiding profiled elements 14, 16. Two of the guiding elements 17, 18 are arranged on or at the first guiding profiled element 14, and one of the guiding elements 19 is arranged on or at the second guiding profiled element 16, so that the three guiding elements have or define a V-shaped arrangement on the door element. The first guiding profiled element 14 is arranged, in relation to the extent of the door element 12, at a first upper end 11, and the second guiding profiled element 16 is arranged accordingly at an opposite second lower end 13 of the device 10.

In FIG. 2 a cross-sectional illustration of the device 10 along section A-A′ in FIG. 1 is illustrated, which shows the door element 12 in its cross-section. In the present embodiment, the door element 12 is configured so as to be C-shaped.

1. A device for guiding a door element comprising:
a first and a second guiding profiled element, wherein the guiding profiled elements are oriented parallel to each other and at a distance from each other; and
three guiding elements guidably connecting or contacting the door element with the first and second guiding profiled elements, wherein two of the guiding elements are guidably located on the first guiding profiled element and another one of the guiding elements is guidably located on the second guiding profiled element, wherein
the device defines a sliding direction of the door element, and the sliding direction defines an axis thereof;
the three guiding elements define a substantially V-shape configuration, and
the door element defines at least two corners, and said two of the guiding elements are located at or near the corners of the door element relative to the axis of the sliding direction, and the third guiding element, relative to a length of the door element, located at an opposite end of the door element from the corners and centrally in the sliding direction so that the three guiding elements substantially define a substantially equally-sided triangle configuration.

2. The device according to claim 1, wherein the first guiding profiled element is located near or at a first upper end of the device, and the second guiding profiled element is located near or at an opposite second lower end of the device.

3. The device according to claim 1, wherein the distance between the first and the second guiding profiled element corresponds substantially to a length of the door element.

4. The device according to claim 1, wherein the door element is configured in a substantial C-shape.

5. The device according to claim 1, wherein each of the three guiding elements comprises at least one runner.

6. The device according to claim 5, wherein said two guiding profiled elements are substantially U-shaped and define a first and a second contact surface.

7. The device according to claim 6, wherein the first and the second contact surfaces of the guiding profiled element define a distance therebetween substantially corresponding to a diameter of the runners.

8. A passenger transport vehicle comprising a device for guiding a door element comprising:
a first and a second guiding profiled element, wherein the guiding profiled elements are oriented parallel to each other and at a distance from each other; and
three guiding elements guidably connecting or contacting the door element with the first and second guiding profiled elements, wherein two of the guiding elements are guidably located on the first guiding profiled element and another one of the guiding elements is guidably located on the second guiding profiled element, wherein
the device defines a sliding direction of the door element, and the sliding direction defines an axis thereof;
the three guiding elements define a substantially V-shape configuration, and
the door element defines at least two corners, and said two of the guiding elements are located at or near the corners of the door element relative to the axis of the sliding direction, and the third guiding element, relative to a length of the door element, is located at an opposite end of the door element from the corners and centrally in the sliding direction so that the three guiding elements substantially define a substantially equally-sided triangle configuration.

9. (canceled)

10. A device as in claim 1, wherein the door element includes a sliding door for a passenger transport vehicle.
